(19) United States
(12) Patent Application Publication
(10) Pub. No.: US 2024/0046691 A1
(43) Pub. Date: Feb. 8, 2024

(54) EXTENDED REALITY SYSTEMS INCLUDING ULTRASOUND-BASED HAPTIC SYSTEMS

(71) Applicant: QUALCOMM Incorporated, San Diego, CA (US)

(72) Inventors: Yipeng LU, Moraga, CA (US); Hrishikesh Vijaykumar PANCHAWAGH, Cupertino, CA (US); Kostadin Dimitrov DJORDJEV, Los Gatos, CA (US)

(21) Appl. No.: 17/817,169

(22) Filed: Aug. 3, 2022

(51) Int. Cl. G06V 40/13; B06B 1/06

(52) U.S. Cl. CPC G06V 40/1306; B06B 1/0622; G10K 11/346

(57) ABSTRACT

Methods, devices and systems for providing extended reality effects are disclosed. In some examples, a control system may control a structure to provide extended reality effects and also may control an ultrasound-based haptic system to create haptic effects via transmitted ultrasonic waves. The ultrasound-based haptic system may include one or more arrays of ultrasonic transducers, such as piezoelectric micromachined ultrasonic transducers (PMUTs), mounted in or on the structure. The haptic effects may be created via air-coupled ultrasonic waves.

### TECHNICAL FIELD

This disclosure relates generally to methods, apparatus and systems for providing extended reality effects.

### DESCRIPTION OF THE RELATED TECHNOLOGY

The term “extended reality” (XR) refers to all real-and-virtual combined environments and human-machine interactions, including augmented reality (AR), mixed reality (MR) and virtual reality (VR). The levels of virtuality in XR may range from sensory inputs that augment a user's experience of the real world to immersive virtuality, also called VR. Although some existing XR systems provide acceptable performance under some conditions, improved methods and devices would be desirable.

### SUMMARY

The systems, methods and devices of the disclosure each have several innovative aspects, no single one of which is solely responsible for the desirable attributes disclosed herein.

One innovative aspect of the subject matter described in this disclosure may be implemented in an apparatus. According to some examples, the apparatus may include a structure, such as a headset or an eyeglass frame, that is configured to provide extended reality effects. The extended reality effects may include augmented reality effects, mixed reality effects, virtual reality effects, or combinations thereof.

In some examples, the apparatus may include an ultrasound-based haptic system including one or more arrays of ultrasonic transducers, which in some examples may include piezoelectric micromachined ultrasonic transducers (PMUTs), mounted in or on the structure. In some examples, the apparatus may include a control system configured for communication with (such as electrically or wirelessly coupled to) the structure and the ultrasound-based haptic system. In some examples, the control system may include a memory, whereas in other examples the control system may be configured for communication with a memory that is not part of the control system. The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

According to some examples, the control system may be configured to control the one or more arrays of ultrasonic transducers to create haptic effects via ultrasonic waves. In some examples, the control system may be configured to control the one or more arrays of ultrasonic transducers to create haptic effects via air-coupled ultrasonic waves. According to some examples, the control system may be configured to control the one or more arrays of ultrasonic transducers to create one or more haptic effects associated with at least one of the extended reality effects. In some examples, the control system may be configured to control the one or more arrays of ultrasonic transducers to create one or more haptic effects synchronized with at least one of the extended reality effects.

In some implementations, at least one array of the one or more arrays of ultrasonic transducers may include ultrasonic transducers grouped into superpixels. In some such implementations, each of the superpixels may include a plurality of ultrasonic transducers.

According to some examples, the control system may be configured to control at least one array of the one or more arrays of ultrasonic transducers to create haptic effects via beam steering of transmitted ultrasonic waves. In some examples, a beam steering distance of the beam steering may be in a range from 5 mm to 2 cm.

In some examples, the control system may be configured to control at least one array of the one or more arrays of ultrasonic transducers to create haptic effects by modifying a focus area of transmitted ultrasonic waves, modifying a focus depth of transmitted ultrasonic waves, or a combination thereof. In some such examples, modifying the focus area may involve modifying the focus area in a range from 2 mm to 5 cm. In some examples, modifying the focus depth may involve modifying the focus depth in a range from 5 mm to 5 cm.

According to some examples, the control system may be configured to control at least one array of the one or more arrays of ultrasonic transducers to create haptic effects by transmitting a focused beam of ultrasonic waves by the at least one array at a first time and transmitting an unfocused beam of ultrasonic waves by the at least one array at a second time. In some examples, the control system may be configured to control at least one array of the one or more arrays of ultrasonic transducers to create haptic effects by modifying a peak frequency of transmitted ultrasonic waves.

In some examples, the control system may be configured to control at least one array of the one or more arrays of ultrasonic transducers to create haptic effects via amplitude modulation of transmitted ultrasonic carrier waves. In some such examples, a frequency of amplitude modulation may be in a range of 40 Hz to 300 Hz. In some examples, a peak frequency of the transmitted ultrasonic carrier waves may be in a range of 20 KHz to 600 KHz.

According to some examples, the control system may be configured to control at least one array of the one or more arrays of ultrasonic transducers to create haptic effects via ultrasonic waves transmitted to a wearer of the apparatus via solid material. In some such examples, the solid material may include a portion of the structure that may be configured to be in contact with the wearer of the apparatus. According to some examples, the control system may be further configured to control at least one array of the one or more arrays of ultrasonic transducers to create haptic effects by modifying a focus area of transmitted ultrasonic waves in a range of 1 mm to 5 mm, moving a focus area of transmitted ultrasonic waves within a steering range of 1 cm, modifying a focus depth of transmitted ultrasonic waves in a range from 5 mm to 5 cm, or a combination thereof.

In some examples, the control system may be further configured to control at least one array of the one or more arrays of ultrasonic transducers to create haptic effects corresponding to a motion along a trajectory.

According to some examples, the one or more arrays of ultrasonic transducers may include one or more piezoelectric micromachined ultrasonic transducers (PMUTs). The one or more PMUTs may, in some examples, include one or more scandium-doped aluminum nitride PMUTs.

Other innovative aspects of the subject matter described in this disclosure may be implemented in a method. In some examples, the method may involve providing extended reality effects. According to some examples, the method may involve controlling, by a control system, a structure to provide extended reality effects. In some examples, the method may involve controlling, by the control system, one or more arrays of ultrasonic transducers mounted in or on the structure to create haptic effects via transmitted ultrasonic waves. In some examples, creating haptic effects via transmitted ultrasonic waves may involve transmitting air-coupled ultrasonic waves. Alternatively, or additionally, creating haptic effects via transmitted ultrasonic waves may involve transmitting ultrasonic waves through solid material. In some examples, one or more of the haptic effects may be associated with at least one of the extended reality effects, synchronized with at least one of the extended reality effects, or combinations thereof.

Some or all of the operations, functions or methods described herein may be performed by one or more devices according to instructions (such as software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented in one or more non-transitory media having software stored thereon.

For example, the software may include instructions for controlling one or more devices to perform a method. In some examples, the method may involve providing extended reality effects. According to some examples, the method may involve controlling, by a control system, a structure to provide extended reality effects. In some examples, the method may involve controlling, by the control system, one or more arrays of ultrasonic transducers mounted in or on the structure to create haptic effects via transmitted ultrasonic waves. In some examples, creating haptic effects via transmitted ultrasonic waves may involve transmitting air-coupled ultrasonic waves. Alternatively, or additionally, creating haptic effects via transmitted ultrasonic waves may involve transmitting ultrasonic waves through solid material. In some examples, one or more of the haptic effects may be associated with at least one of the extended reality effects, synchronized with at least one of the extended reality effects, or combinations thereof.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a block diagram that presents example components of an apparatus.

FIG. 2A presents an example of the apparatus of FIG. 1 that is configured for communication with another device.

FIG. 2B shows an example in which a structure for proving XR effects is, or includes, an eyeglass frame.

FIG. 3A shows a cross-sectional view of a piezoelectric micromachined ultrasonic transducer (PMUT) according to one example.

FIG. 3B shows a cross-sectional view of a PMUT according to an alternative example.

FIGS. 4A, 4B, 4C and 4D show examples of how an array of ultrasonic transducer elements may be controlled to produce transmitted beams of ultrasonic waves suitable for producing haptic effects.

FIG. 5 is a flow diagram that presents examples of operations according to some disclosed methods.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein may be applied in a multitude of different ways. The described implementations may be implemented in any device, apparatus, or system that includes a biometric system as disclosed herein. In addition, it is contemplated that the described implementations may be included in or associated with a variety of electronic devices such as, but not limited to: mobile telephones, multimedia Internet enabled cellular telephones, mobile television receivers, wireless devices, smartphones, smart cards, wearable devices such as bracelets, armbands, wristbands, rings, headbands, patches, etc., Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (such as e-readers), mobile health devices, computer monitors, automobile components, including but not limited to automobile displays (such as odometer and speedometer displays, etc.), cockpit controls or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also may be used in applications such as, but not limited to, electronic switching devices, radio frequency filters, sensors, accelerometers, gyroscopes, motion-sensing devices, magnetometers, inertial components for consumer electronics, parts of consumer electronics products, steering wheels or other automobile parts, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Providing haptic feedback, in addition to audio and video effects, can create a relatively more immersive extended reality (XR) experience. For example, there is an existing device for creating touch sensations as part of providing an XR experience. This device is about half the size of a typical laptop computer. Accordingly, the device is rather bulky and heavy, and consumes a relatively large amount of power during use.

Some disclosed implementations include an ultrasound-based haptic system for use with, or which may be configured as part of, an XR system. Some implementations may provide an ultrasound-based haptic system that includes one or more arrays of ultrasonic transducer elements, which may in some examples include piezoelectric micromachined ultrasonic transducers (PMUTs), mounted in or on a structure configured to provide XR effects. In some such implementations, a control system may be configured to control the one or more arrays of ultrasonic transducer elements to create haptic effects via ultrasonic waves. In some examples, the control system may be configured to control the one or more arrays of ultrasonic transducer elements to create haptic effects via air-coupled ultrasonic waves. The haptic effect(s) may be associated with at least one of the extended reality effects, such as at least one visual extended reality effect. In some instances, the haptic effect(s) may be synchronized with at least one of the extended reality effects, such as at least one visual extended reality effect.

Particular implementations of the subject matter described in this disclosure may be implemented to realize one or more of the following potential advantages. In some implementations, an apparatus may include an ultrasound-based haptic system that is smaller than, lighter than and that may consume less power than, prior haptic systems provided for use with, or deployed as part of, an XR system. Some such ultrasound-based haptic system implementations are small enough and light enough to deploy as part of an XR headset or an eyeglass frame without the ultrasound-based haptic system appreciably increasing the weight of the headset or eyeglass frame. In some implementations, haptic effects may be provided via air-coupled ultrasonic waves. Such implementations may be capable of providing haptic effects even to areas of a user's head that are not in contact with the XR headset or eyeglass frame. Alternatively, or additionally, some implementations provide haptic effects via ultrasonic waves transmitted to a wearer of the apparatus via solid material, such as a portion of the structure that is configured to be in contact with the wearer of the apparatus. An ultrasound-based haptic system can provide sensations to a device wearer without disturbing other nearby people. Some ultrasound-based haptic systems may be configured to produce a variety of different sensations. In some such implementations, each of the different sensations may correspond with an intended use case, a particular type of XR experience, or combinations thereof.

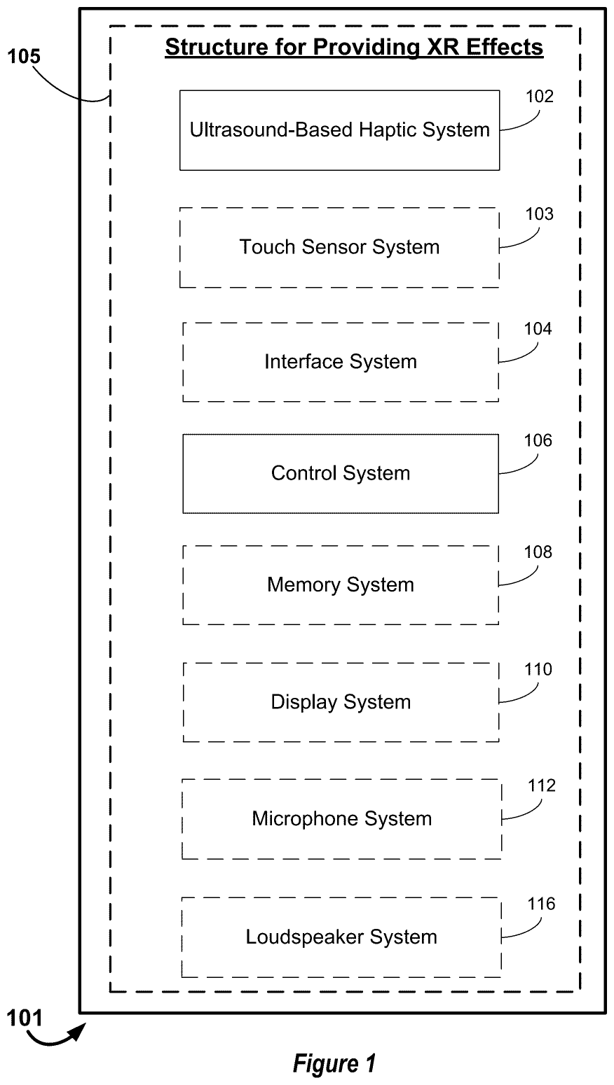

FIG. 1 is a block diagram that presents example components of an apparatus. In this example, the apparatus 101 includes a structure 105 configured to provide extended reality (XR) effects, an ultrasound-based haptic system 102 and a control system 106. Some implementations may include a touch sensor system 103, an interface system 104, a memory system 108, a display system 110, a microphone system 112, a loudspeaker system 116, or combinations thereof. In this example, the ultrasound-based haptic system 102, the control system 106 and the optional touch sensor system 103, interface system 104, memory system 108, display system 110, microphone system 112 and loudspeaker system 116 are shown as being within a dashed rectangle that represents the structure 105, indicating that these components are part of the structure 105, mounted on the structure 105, reside within the structure 105, or combinations thereof. In some examples, the structure 105 may be, or may include, a headset or an eyeglass frame.

In some examples, the ultrasound-based haptic system 102 may include one or more arrays of ultrasonic transducer elements, such as one or more arrays of piezoelectric micromachined ultrasonic transducers (PMUTs), one or more arrays of capacitive micromachined ultrasonic transducers (CMUTs), etc. According to some examples, the ultrasonic transducer elements may include one or more piezoelectric layers, such as one or more layers of polyvinylidene fluoride PVDF polymer, polyvinylidene fluoride-trifluoroethylene (PVDF-TrFE) copolymer, scandium-doped aluminum nitride (SLAIN), or a combination thereof. In some such examples, PMUT elements in a single-layer array of PMUTs or CMUT elements in a single-layer array of CMUTs may be used as ultrasonic transmitters as well as ultrasonic receivers. However, in some examples the PMUTs, CMUTs or combinations thereof may be configured to transmit ultrasonic waves, but not to provide signals to the control system 106 corresponding to received ultrasonic waves.

The touch sensor system 103 (if present) may be, or may include, a resistive touch sensor system, a surface capacitive touch sensor system, a projected capacitive touch sensor system, a surface acoustic wave touch sensor system, an infrared touch sensor system, or any other suitable type of touch sensor system.

The control system 106 may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. According to some examples, the control system 106 also may include one or more memory devices, such as one or more random access memory (RAM) devices, read-only memory (ROM) devices, etc.

In this example, the control system 106 is configured for communication with, and configured for controlling, elements of the structure 105 to provide XR effects. The XR effects may include visual effects provided by the display system 110, audio effects provided by the loudspeaker system 116, or combinations thereof. For example, the structure 105 may be an XR headset and the control system 106 may be configured for controlling elements of the XR headset to provide XR effects. In other examples, the structure 105 may be an eyeglass frame and the control system 106 may be configured for controlling elements of the eyeglass frame to provide XR effects. According to some examples, the control system 106 is configured for communication with, and for controlling, the ultrasound-based haptic system 102 to provide haptic effects. In some such examples, the control system 106 may be configured to control one or more arrays of ultrasonic transducer elements, such as PMUTs, of the ultrasound-based haptic system 102 to create one or more haptic effects associated with at least one of the XR effects, e.g., associated with at least one visual XR effect, associated with at least one audio XR effect, or a combination thereof. In some examples, the control system 106 may be configured to control one or more arrays of ultrasonic transducer elements of the ultrasound-based haptic system 102 to create one or more haptic effects synchronized with at least one of the XR effects, e.g., synchronized with at least one visual XR effect, synchronized with at least one audio XR effect, or a combination thereof.

In implementations where the apparatus includes a touch sensor system 103, the control system 106 is configured for communication with, and for controlling, the touch sensor system 103. In implementations where the apparatus includes a memory system 108 that is separate from the control system 106, the control system 106 also may be configured for communication with the memory system 108. In implementations where the apparatus includes a microphone system 112, the control system 106 is configured for communication with, and for controlling, the microphone system 112. According to some examples, the control system 106 may include one or more dedicated components for controlling the ultrasound-based haptic system 102, the touch sensor system 103, the memory system 108, the display system 110 or the microphone system 112. In some implementations, functionality of the control system 106 may be partitioned between one or more controllers or processors, such as between a dedicated sensor controller and an applications processor of a mobile device.

In some examples, the memory system 108 may include one or more memory devices, such as one or more RAM devices, ROM devices, etc. In some implementations, the memory system 108 may include one or more computer-readable media, storage media or storage media. Computer-readable media include both computer storage media and communication media including any medium that may be enabled to transfer a computer program from one place to another. Storage media may be any available media that may be accessed by a computer. In some examples, the memory system 108 may include one or more non-transitory media. By way of example, and not limitation, non-transitory media may include RAM, ROM, electrically erasable programmable read-only memory (EEPROM), compact disc ROM (CD-ROM) or other optical disk storage, magnetic disk storage or other magnetic storage devices, or any other medium that may be used to store desired program code in the form of instructions or data structures and that may be accessed by a computer.

Some implementations of the apparatus 101 may include an interface system 104. In some examples, the interface system 104 may include a wireless interface system. In some implementations, the interface system 104 may include a user interface system, one or more network interfaces, one or more interfaces between the control system 106 and the ultrasound-based haptic system 102, one or more interfaces between the control system 106 and the touch sensor system 103, one or more interfaces between the control system 106 and the memory system 108, one or more interfaces between the control system 106 and the display system 110, one or more interfaces between the control system 106 and the microphone system 112, one or more interfaces between the control system 106 and the loudspeaker system 116, one or more interfaces between the control system 106 and one or more external device interfaces (such as ports or applications processors), or combinations thereof.

The interface system 104 may be configured to provide communication (which may include wired or wireless communication, electrical communication, radio communication, etc.) between components of the apparatus 101. In some such examples, the interface system 104 may be configured to provide communication between the control system 106 and the ultrasound-based haptic system 102. According to some such examples, the interface system 104 may couple at least a portion of the control system 106 to the ultrasound-based haptic system 102 and the interface system 104 may couple at least a portion of the control system 106 to the touch sensor system 103, such as via electrically conducting material (for example, via conductive metal wires or traces). According to some examples, the interface system 104 may be configured to provide communication between the apparatus 101 and one or more other devices. In some examples, the interface system 104 may be configured to provide communication between the apparatus 101 and a human being. In some such examples, the interface system 104 may include one or more user interfaces. In some examples, the user interface(s) may be provided via the touch sensor system 103, the display system 110, the microphone system 112, the gesture sensor system, or combinations thereof. The interface system 104 may, in some examples, include one or more network interfaces or one or more external device interfaces (such as one or more universal serial bus (USB) interfaces or a serial peripheral interface (SPI)).

In some examples, the apparatus 101 may include a display system 110 having one or more displays. In some examples, the display system 110 may be, or may include, a light-emitting diode (LED) display, such as an organic light-emitting diode (OLED) display. In some such examples, the display system 110 may include layers, which may be referred to collectively as a “display stack.”

In some implementations, the apparatus 101 may include a microphone system 112. The microphone system 112 may include one or more microphones.

In some implementations, the apparatus 101 may include a loudspeaker system 116. The loudspeaker system 116 may be, or may include, one or more loudspeakers or groups of loudspeakers. In some examples, the loudspeaker system 116 may include one or more loudspeakers, or one or more groups of loudspeakers, corresponding to a left ear and one or more loudspeakers, or one or more groups of loudspeakers, corresponding to a right ear. In some implementations, at least a portion of the loudspeaker system 116 may reside within an earcup, an earbud, etc. In some examples, at least a portion of the loudspeaker system 116 may reside in or on a portion of an eyeglass frame that is intended to reside near a wearer's ear or touching the wearer's ear.

The apparatus 101 may be used in a variety of different contexts, some examples of which are disclosed herein. For example, in some implementations a mobile device may include at least a portion of the apparatus 101. In some implementations, a wearable device may include at least a portion of the apparatus 101. The wearable device may, for example, be a headset or an eyeglass frame. In some implementations, the control system 106 may reside in more than one device. For example, a portion of the control system 106 may reside in a wearable device and another portion of the control system 106 may reside in another device, such as a mobile device (for example, a smartphone), a server, etc. The interface system 104 also may, in some such examples, reside in more than one device.

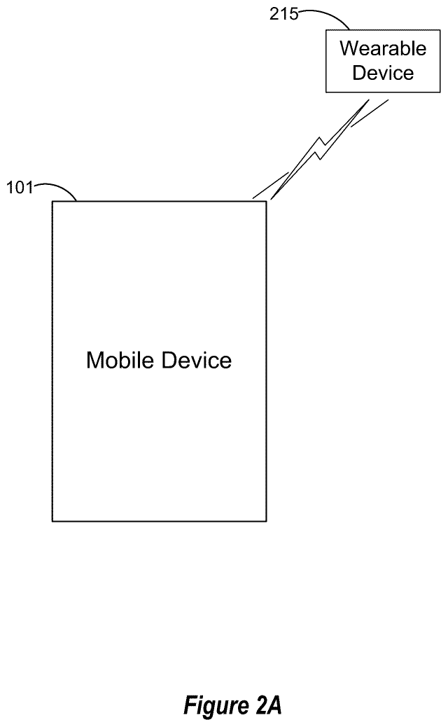

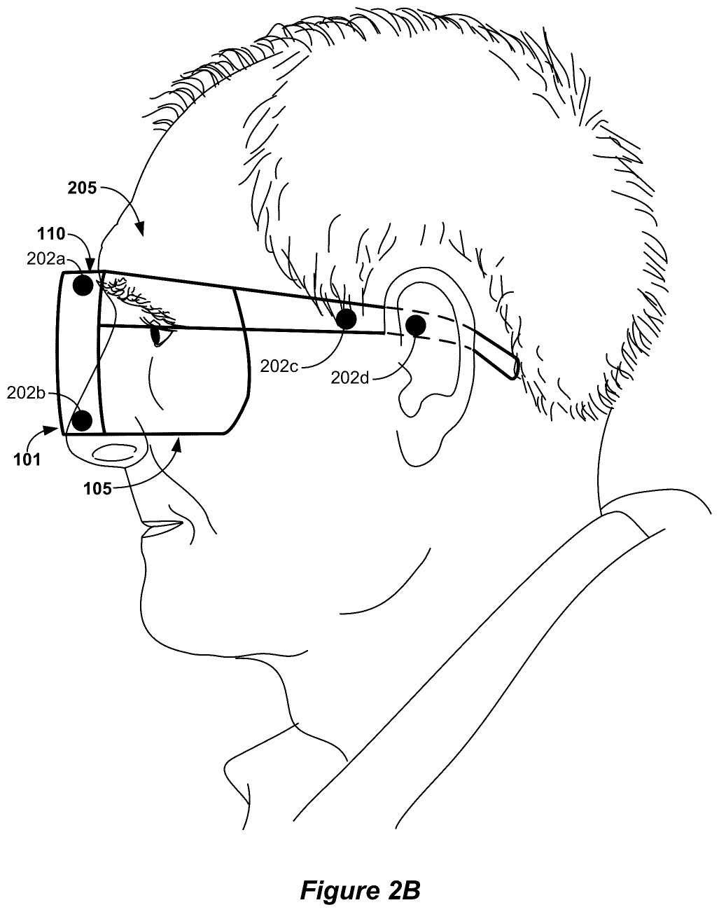

FIG. 2A presents an example of the apparatus of FIG. 1 that is configured for communication with another device. The numbers, types and arrangements of elements shown in the figures provided herein, including but not limited to FIG. 2A, are merely examples. Other examples may include different elements, different arrangements of elements, or combinations thereof.

According to this example, the apparatus 101 is a mobile device, such as a cellular telephone. FIG. 2A also illustrates a wearable device 215 that is configured for wireless communication with the apparatus 101. The wearable device 215 may, for example, be a watch, one or more earbuds, headphones, a headset, an eyeglass frame, etc. In this example, the same person may be the authorized user for both the apparatus 101 and the wearable device 215. According to some implementations, the wearable device 215 may include some or all of the elements shown in FIG. 1, some or all of the elements shown in FIG. 2B, or combinations thereof.

FIG. 2A is an example of an implementation in which the control system 106 of FIG. 1 may reside in more than one device. For example, a portion of the control system 106 may reside in the wearable device 215 and another portion of the control system 106 may reside in the mobile device 101. The interface system 104 of FIG. 1 also may, in some such examples, reside in both the wearable device 215 and the mobile device 101.

FIG. 2B shows an example in which a structure for proving XR effects is, or includes, an eyeglass frame. The numbers, types and arrangements of elements shown in FIG. 2B are merely examples. Other examples may include different elements, different arrangements of elements, or combinations thereof. In this example, the apparatus 101 is an instance of the apparatus 101 that is described above with reference to FIG. 1. In this example, the structure 105 is an eyeglass frame that includes elements for providing XR effects. According to this example, the apparatus 101 includes a display system 110 residing in or on the structure 105. In this example, the display system 110 is configured to provide visual XR effects according to signals from a control system (not shown), which may be an instance of the control system 106 that is described herein with reference to FIG. 1 In some examples, the apparatus 101 also may include a loudspeaker system 116 (not shown) that is configured to provide audio XR effects according to signals from a control system.

In this implementation, the apparatus 101 includes arrays of ultrasonic transducer elements 202a, 202b, 202c and 202d. According to this implementation, the arrays of ultrasonic transducer elements 202a-202d are components of an ultrasound-based haptic system, which is an instance of the ultrasound-based haptic system 102 that is described herein with reference to FIG. 1. In some implementations, the arrays of ultrasonic transducer elements 202a-202d may be, or may include PMUTs. According to some implementations, the arrays of ultrasonic transducer elements 202a-202d may be small enough and light enough that they do not appreciably increase the weight of the structure 105. For example, the individual PMUTS of an array of PMUTs may have a diameter of less than 1 mm and a thickness on the order of hundreds of microns. Assuming an overall PMUT package, including protective film(s), of 3.5 mm by 3.5 mm by 1 mm, the weight of an individual PMUT would be less than 0.2 grams.

Although the arrays of ultrasonic transducer elements 202a-202d are illustrated as circles in FIG. 2B, this is merely for the purpose of illustration and to make the arrays of ultrasonic transducer elements 202a-202d easy to identify in FIG. 2B. The arrays of ultrasonic transducer elements 202a-202d may be, or may include, linear arrays, rectangular arrays, polygonal arrays of another shape, etc. Moreover, although it may appear that the arrays of ultrasonic transducer elements 202a-202d reside in or on an outward-facing surface of the structure 105 (in other words, in or on a surface of the structure 105 that is facing away from the wearer 205), in some implementations most of the arrays, or all of the arrays, of ultrasonic transducer elements 202a-202d may reside in or on an inward-facing surface of the structure 105 (in other words, in or on an inner surface of the structure 105, at least part of which is facing towards the wearer 205).

In this example, the control system is configured for controlling the arrays of ultrasonic transducer elements 202a-202d to provide haptic effects. In some such examples, the control system may be configured for controlling the arrays of ultrasonic transducer elements 202a-202d to create one or more haptic effects associated with at least one of the XR effects provided by the structure 105, e.g., associated with at least one visual XR effect, associated with at least one audio XR effect, or a combination thereof. In some examples, the control system may be configured for controlling the arrays of ultrasonic transducer elements 202a-202d to create one or more haptic effects synchronized with at least one of the XR effects provided by the structure 105, e.g., synchronized with at least one visual XR effect, synchronized with at least one audio XR effect, or a combination thereof.

In this implementation, the control system is configured to control one or more of the arrays of ultrasonic transducer elements 202a-202d (for example, the arrays of ultrasonic transducer elements 202a and 202b) to provide haptic effects via air-coupled ultrasonic waves. Such implementations may be capable of providing haptic effects to areas of the wearer 205's head that are not in contact with the eyeglass frame, such as the wearer 205's eyebrow area, forehead area, cheek area, the area surrounding the wearer 205's eyes, the area between the wearer 205's eyes and the wearer 205's temples, etc.

According to this implementation, the control system is also configured to control one or more of the arrays of ultrasonic transducer elements 202a-202d (for example, the arrays of ultrasonic transducer elements 202c and 202d) to provide haptic effects via ultrasonic waves transmitted to a wearer of the apparatus via one or more portions of the structure 105 that are configured to be in contact with the wearer of the apparatus. For example, the arrays of ultrasonic transducer elements 202c and 205d may reside in portions of the structure 105 that are configured to be in contact with the wearer 205's temple and an area of the wearer 205's head that is behind the wearer 205's ear, respectively. According to some implementations, the array of ultrasonic transducer elements 205d may reside in a portion of the structure 105 that is configured to be in contact with a “backside” portion of the wearer 205's ear that is facing the wearer 205's head. According to some such implementations, the array of ultrasonic transducer elements 205d may reside in or on an outward-facing portion of the structure 105 that is configured to face the backside portion of the wearer 205's ear. In some implementations, there may be only a thin layer or a thin stack of material (such as one or more protective layers, one or more impedance-matching layers, etc.) between the arrays of ultrasonic transducer elements 202c and 205d and the wearer 205's skin.

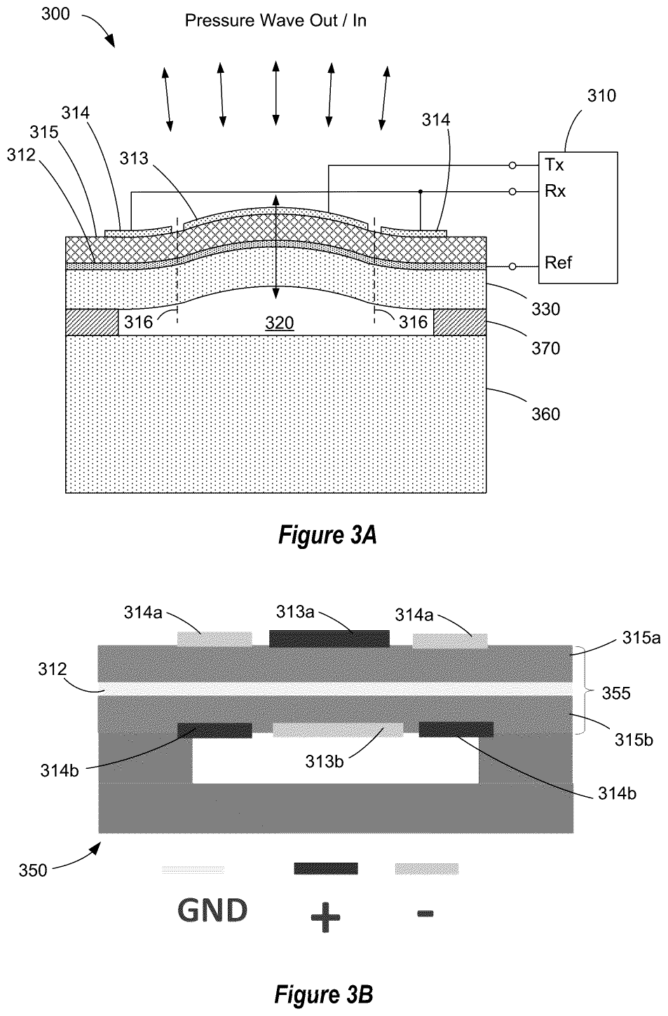

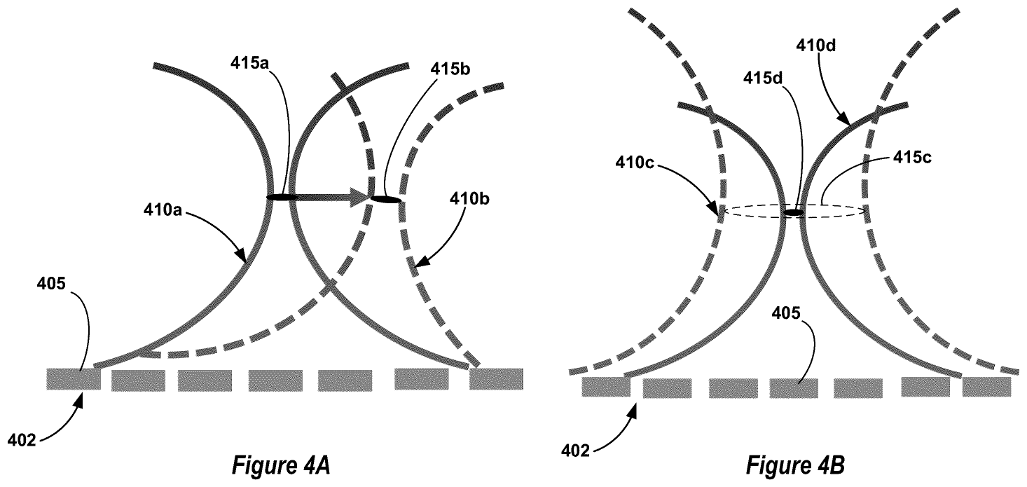

FIG. 3A shows a cross-sectional view of a piezoelectric micromachined ultrasonic transducer (PMUT) according to one example. The numbers, types and arrangements of elements shown in FIG. 3A are merely examples. Other examples may include different elements, different arrangements of elements, or combinations thereof.

FIG. 3A illustrates an arrangement of a three-port PMUT coupled with transceiver circuitry 310. In the illustrated implementation, the lower electrode 312, inner electrode 313 and outer electrodes 314 may be electrically coupled with transceiver circuitry 310 and may function as separate electrodes providing, respectively, signal transmission, signal reception, and a common reference or ground. In some examples, the electrode 314 may have a ring shape and the electrode 313 may have a circular shape, with the electrode 313 residing within the ring of the electrode 314. This arrangement allows timing of transmit (Tx) and receive (Rx) signals to be independent of each other. More particularly, the illustrated arrangement enables substantially simultaneous transmission and reception of signals between piezoelectric ultrasonic transducer 300 and transceiver circuitry 310.

Advantageously, transmit and receive electrodes may be formed in the same electrode layer during a common fabrication process of deposition, masking and etching, for example. In some implementations, one or more piezoelectric layers and associated electrode layers (not shown) may be included in the piezoelectric layer 315, in which case the piezoelectric layer 315 may be referred to as a piezoelectric stack. According to some examples, the piezoelectric layer 315 may include polyvinylidene fluoride PVDF polymer, polyvinylidene fluoride-trifluoroethylene (PVDF-TrFE) copolymer, scandium-doped aluminum nitride (SLAIN), or a combination thereof.

Referring still to FIG. 3A, transceiver circuitry 310 may be electrically coupled with piezoelectric ultrasonic transducer 300 by way of three input/output terminals or ports associated with the transceiver circuitry 310 and three electrodes 312, 313 and 314 associated with the three-port PMUT. In the illustrated implementation, a first terminal or port is electrically coupled with the lower (reference) electrode 312; a second terminal or port is electrically coupled with the inner (transmit) electrode 313; and a third terminal or port is electrically coupled with the outer (receive) electrode(s) 314.

It should be noted that in the illustrated arrangement, portions of the piezoelectric layer 315 that are proximate to the outer electrodes 314 are in an opposite state of mechanical stress compared to portions of the piezoelectric layer 315 that are proximate to the inner electrode 313 during vibrations of the PMUT diaphragm. More particularly, at the instantaneous moment illustrated in FIG. 3A, portions of the piezoelectric layer 315 that are proximate to the outer electrode 314 are in compression, whereas portions of the piezoelectric layer 315 that are proximate to the inner electrode 313 are in tension. Thus, the arrangement may use a difference in the mechanical strain direction on an inside area of the diaphragm compared to an outside area of the diaphragm to improve transmitter and receiver efficiency. For example, where the PMUT cavity 320 is circular, for a portion of the diaphragm 340 disposed over the PMUT cavity 320 (the “suspended portion” of diaphragm 340), an inflection zone exists at about 60-70% of the cavity radius, i.e. the stress direction on the same side (e.g. top or bottom) of piezoelectric layer 315 is of opposite sense on either side of the inflection zone. An approximate location of the inflection zone is indicated by dashed lines 316 in FIG. 3A, with inner electrode 313 and outer electrode 314 shown on opposite sides of the inflection zone.

To maximize the transmitter and receiver efficiencies, it is desirable to cover the maximum possible area on the suspended portion having a common sense of stress (e.g. either tensile or compressive). Thus, transmitter and receiver efficiencies may be improved by positioning the outer perimeter of the inner electrode 313 and the inner perimeter of the outer electrode 314 close to the inflection zone. For other shapes such as rectangular or square diaphragms, a similar approach may be applied to optimize the electrode shapes. An outer edge of the outer electrode 314 may be substantially aligned with a perimeter of the cavity 320 or may (as illustrated) extend beyond the walls of the cavity 320.

The PMUT diaphragm may be supported by an anchor structure 370 that allows the diaphragm to extend over the cavity 320. The diaphragm may undergo flexural motion when the PMUT receives or transmits ultrasonic signals. The PMUT diaphragm may operate in a first flexural mode when receiving or transmitting ultrasonic signals. In some implementations, when operating in the first flexural mode, the inner and outer electrodes may experience a respective first and second oscillating load cycle that includes alternating periods of tensile and compressive stress. The first and second oscillating load cycles may be out of phase, that is, one being tensile while the other is compressive on each side of the inflection zone, as shown in FIG. 3A. The first and second oscillating load cycles may be approximately 180° out of phase. In other implementations, the first and second oscillating load cycles may be approximately in phase.

FIG. 3B shows a cross-sectional view of a PMUT according to an alternative example. The numbers, types and arrangements of elements shown in FIG. 3B are merely examples. Other examples may include different elements, different arrangements of elements, or combinations thereof.

The PMUT 350 of FIG. 3B is similar to the PMUT 300 of FIG. 3A. However, the implementation shown in FIG. 3B includes two instances of the electrodes 313 and 314 of FIG. 3A, and two instances of the piezoelectric layer 315 of FIG. 3A. In FIG. 3B, the electrodes corresponding to electrode 313 are identified as electrodes 313a and 313b, and the electrodes corresponding to electrode 314 are identified as electrodes 314a and 314b. In this example, the piezoelectric layer 315a and the electrodes 313a and 314a are on a first side of the reference electrode 312, which is an outer side in this example. In the example of FIG. 3B, the piezoelectric layer 315b and the electrodes 313b and 314b are on a second side of the reference electrode 312, which is an inner side in this example. According to some examples, the piezoelectric layers 315a and 315b may include polyvinylidene fluoride PVDF polymer, polyvinylidene fluoride-trifluoroethylene (PVDF-TrFE) copolymer, scandium-doped aluminum nitride (SLAIN), or a combination thereof.

As suggested by the plus and minus signs in FIG. 3B, in some examples the PMUT 350 may be controlled according to a differential drive scheme, according to which transmission pressure may be substantially increased (in some examples, by approximately four times) as compared to the transmission pressure that may be produced by the PMUT 300 of FIG. 3A. In this example, the differential drive scheme involves driving electrode 313a up when electrode 314a is driven down, driving electrode 313b up when electrode 314b is driven down, driving electrode 313a up when electrode 313b is driven down, driving electrode 314b up when electrode 314b is driven down, and vice versa. In some such examples, the control system may be configured to drive electrode 313a approximately 180 degrees out of phase from electrodes 314a and 313b, and configured to drive electrode 313a approximately in phase with electrode 314b. In this context “approximately” may refer to a range that is plus or minus 5 degrees, plus or minus 10 degrees, plus or minus 15 degrees, plus or minus 20 degrees, plus or minus 25 degrees, etc. In some examples, the PMUT 300 of FIG. 3A also may be driven according to a differential drive scheme, e.g., in which the control system may be configured to drive the electrode 313 approximately 180 degrees out of phase from the electrode 314.

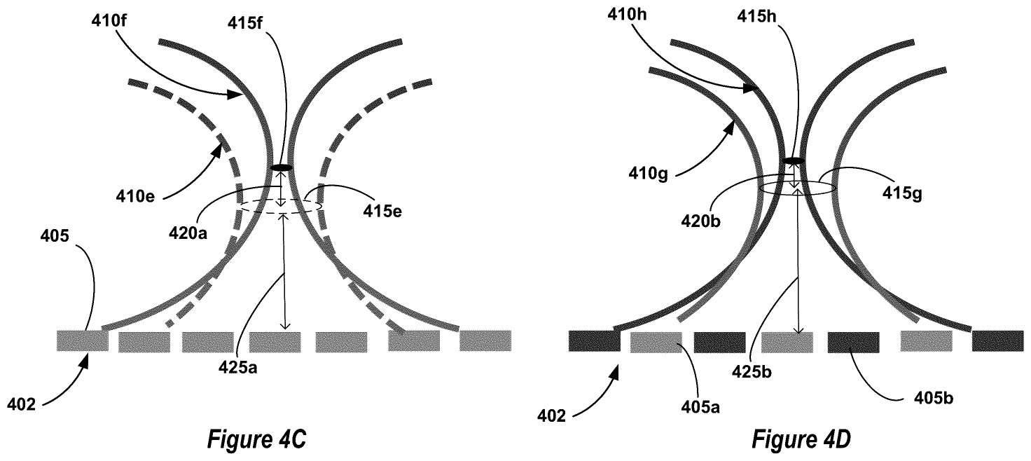

FIGS. 4A, 4B, 4C and 4D show examples of how an array of ultrasonic transducer elements may be controlled to produce transmitted beams of ultrasonic waves suitable for producing haptic effects. In some examples, the arrays of ultrasonic transducer elements 402 shown in FIGS. 4A-4D may be instances of the arrays of ultrasonic transducer elements 202a-202d that are described with reference to FIG. 2B. As with other disclosed implementations, the numbers, types and arrangements of elements shown in FIGS. 4A-4D are only provided by way of example. For example, in FIGS. 4A-4D the arrays of ultrasonic transducer elements 402 are shown to have only a few ultrasonic transducer elements 405 (or groups of ultrasonic transducer elements 405) for ease of illustration, whereas in some implementations the arrays of ultrasonic transducer elements 402 may have substantially more ultrasonic transducer elements 405, such as tens of ultrasonic transducer elements 405, hundreds of ultrasonic transducer elements 405, etc.

According to some examples, one or more (and in some cases, all) of the dashes 405 shown in FIGS. 4A-4D may represent groups of two or more ultrasonic transducer elements, which also may be referred to herein as “superpixels.” In some such examples, the arrays of ultrasonic transducer elements 402 may be, or may include, arrays of superpixels.

In these examples, the arrays of ultrasonic transducer elements 402 shown in FIGS. 4A-4D are, or include, linear arrays. In some such examples, the linear arrays may be in the range of 5 mm to 20 mm in length, such as 5 mm, 6 mm, 8 mm, 10 mm, 12 mm, 15 mm, 18 mm, 20 mm, 22 mm, 25 mm, etc. In some examples, individual ultrasonic transducer elements 405 may be spaced apart by a distance that is on the order of a desired peak wavelength, such as in the range of half of the desired peak wavelength to two times the desired peak wavelength, corresponding to a desired peak frequency. If an array of ultrasonic transducer elements 406 is configured to create haptic effects via air-coupled ultrasonic waves, the desired peak wavelength may correspond to the desired peak frequency and the velocity of sound in air. Although in FIGS. 4A-4D the arrays of ultrasonic transducer elements 402 are shown to be linear arrays, some examples may include areal arrays, such as rectangular arrays, hexagonal arrays, arrays in another polygonal shape, circular arrays, etc. According to some such examples, the arrays of ultrasonic transducer elements 402 shown in FIGS. 4A-4D may be cross-sections through one or more such areal arrays.

In some implementations, the arrays of ultrasonic transducer elements 402 may include PMUTs. However, in some implementations, the arrays of ultrasonic transducer elements 402 may include one or more other types of ultrasonic transducer elements, such as CMUTs.

In some examples, each of the individual ultrasonic transducer elements 405 (or each of the individual ultrasonic transducer elements in an array of superpixels) may have a diameter in the range of hundreds of microns, such as 200 microns, 300 microns, 400 microns, 500 microns, 600 microns, 700 microns, 800 microns, etc. According to some examples, some arrays of ultrasonic transducer elements 402 may include different sizes of individual ultrasonic transducer elements 405. Such examples may be configured to produce more than one peak frequency of ultrasonic waves. For example, relatively larger ultrasonic transducer elements 405 may be configured for producing relatively lower peak frequencies of ultrasonic waves than relatively smaller ultrasonic transducer elements 405, because the peak frequency is inversely proportional to the diameter squared. According to one such example, an array of ultrasonic transducer elements 402 may include some ultrasonic transducer elements 405 having a diameter of 400 microns and other ultrasonic transducer elements 405 having a diameter of 800 microns. Other examples may include larger ultrasonic transducer elements, smaller ultrasonic transducer elements, or a combination thereof. In some examples, each of the individual ultrasonic transducer elements in a superpixel may have the same diameter.

According to some implementations, a control system (not shown) may control the array of ultrasonic transducer elements 402 to create haptic effects via amplitude modulation of transmitted ultrasonic carrier waves. In some such implementations, the ultrasonic carrier wave may be in the range of 20 KHz to 600 KHz. In some implementations, the ultrasonic carrier wave may be an amplitude-modulated carrier wave. According to some such implementations, the frequency of amplitude modulation may be in a range of 40 Hz to 300 Hz.

Referring to FIG. 4A, a control system is controlling an array of ultrasonic transducer elements 402 to transmit a first beam of ultrasonic waves 410a at a first time and to transmit a second beam of ultrasonic waves 410b at a second time. In this example, the control system is controlling the array of ultrasonic transducer elements 402 to focus the first beam of ultrasonic waves 410a in a first focus area 415a and to focus the second beam of ultrasonic waves 410b in a second focus area 415b. In some such examples, the control system may control the array of ultrasonic transducer elements 402 to produce the first focus area 415a and the second focus area 415b on or in a person's skin, such as the skin of the wearer 205 of FIG. 2B.

According to some such examples, movement of the focus area may create a haptic effect of motion along a trajectory corresponding to differing positions of a range of focus areas, which may include the first focus area 415a and the second focus area 415b, over time. In some examples, the trajectory may be a linear trajectory, a curved trajectory, an oval trajectory, a circular trajectory, a sinusoidal trajectory, or combinations thereof.

Accordingly, FIG. 4A shows an example of a control system controlling an array of ultrasonic transducer elements 402 to create haptic effects via beam steering of transmitted ultrasonic waves. In some such examples, controlling an array of ultrasonic transducer elements 402 to create haptic effects via beam steering may involve changing the position of a focus area across a “beam steering distance.” For example, if the first focus area 415a is an initial focus area of the beam steering distance and the second focus area 415b is a final focus area of the beam steering distance, the total beam steering distance may be represented by a trajectory between the first focus area 415a and the second focus area 415b. According to some examples, the beam steering distance may be in the range of 5 mm to 2 cm. In other examples, the beam steering distance may be a larger distance or a smaller distance.

FIGS. 4B and 4C show examples in which a control system is configured to control an array of ultrasonic transducer elements 402 to create haptic effects by modifying a focus area of transmitted ultrasonic waves. In FIG. 4B, a control system is controlling an array of ultrasonic transducer elements 402 to transmit a beam of ultrasonic waves 410c at a first time and to transmit a beam of ultrasonic waves 410d at a second time. In this example, the beam of ultrasonic waves 410c may be regarded as unfocused, because it is focused on a relatively large focus area 415c, whereas the beam of ultrasonic waves 410d is focused in a small focus area 415d. In some examples, the relatively large focus area 415c may have a diameter of multiple centimeters, such as 3 cm, 4 cm, 5 cm, 6 cm, 7 cm, etc. According to some examples, the focus area 415d may have a diameter of on the order of millimeters, such as 1 mm, 2 mm, 3 mm, 4 mm, 5 mm, 6 mm, 7 mm, etc.

According to some examples, the control system may control the array of ultrasonic transducer elements 402 to produce at least the focus area 415d, and in some examples both focus area 415c and the focus area 415d, on or within a person's skin, such as on or in the skin of the wearer 205 of FIG. 2B. In some such examples, the large focus area 415c may disperse the energy of the beam of ultrasonic waves 410c to the extent that little or no haptic effect is produced, whereas the small focus area 415d may concentrate the energy of the beam of ultrasonic waves 410d to the extent that a noticeable haptic effect is produced. By controlling the array of ultrasonic transducer elements 402 to alternate between transmitting focused and unfocused beams of ultrasonic waves, a control system may produce intermittent haptic effects.

In FIG. 4C, a control system is controlling an array of ultrasonic transducer elements 402 to transmit a beam of ultrasonic waves 410e at a first time and to transmit a beam of ultrasonic waves 410f at a second time. In this example, the beam of ultrasonic waves 410e is focused on a relatively larger focus area 415e, whereas the beam of ultrasonic waves 410f is focused in a relatively smaller focus area 415f. In some examples, the relatively larger focus area 415e may have a diameter on the order of centimeters, such as 1 cm, 2 cm, 3 cm, 4 cm, 5 cm, etc. According to some examples, the focus area 415f may have a diameter of on the order of millimeters, such as 1 mm, 2 mm, 3 mm, 4 mm, 5 mm, 5 mm, 6 mm, etc.

In some such examples, the larger focus area 415e may disperse the energy of the beam of ultrasonic waves 410e to the extent that little or no haptic effect is produced, whereas the smaller focus area 415f may concentrate the energy of the beam of ultrasonic waves 410f to the extent that a noticeable haptic effect is produced. By controlling the array of ultrasonic transducer elements 402 to alternate between transmitting relatively less focused and relatively more focused beams of ultrasonic waves, a control system may produce intermittent haptic effects, or haptic effects that change over time.

In this example, the control system is controlling the array of ultrasonic transducer elements 402 to modify both a focus area and a focus depth of transmitted ultrasonic waves. In some such examples, the focus area may be modified in a range from 2 mm to 5 cm. However, alternative examples may involve modifying the focus area in a smaller or a larger range. According to this example, the focus depth changes by at least a distance 420a, which is the distance between the focus area 415e and the focus area 415f. Some such examples may involve modifying the focus depth in a range from 5 mm to 5 cm. However, alternative examples may involve modifying the focus depth in a smaller or a larger range.

In some examples, the control system may control the array of ultrasonic transducer elements 402 to produce at least the focus area 415f, and in some examples the focus areas 415e and 415f, on or in a person's skin, such as the skin of the wearer 205 of FIG. 2B. In some such examples, the distance 425a may correspond to a distance from the array of ultrasonic transducer elements 402 to a position on or in the skin of the wearer 205 of FIG. 2B. In such examples, the focus area 415f may be at least the distance 420a below the surface of the skin of the wearer 205.

In FIG. 4D, a control system is controlling the array of ultrasonic transducer elements 402 to transmit a beam of ultrasonic waves 410g at a first time and to transmit a beam of ultrasonic waves 410h at a second time. In this example, the beam of ultrasonic waves 410g is focused on a relatively larger focus area 415g, whereas the beam of ultrasonic waves 410h is focused in a relatively smaller focus area 415h. In some examples, the relatively larger focus area 415g may have a diameter on the order of centimeters, such as 1 cm, 2 cm, 3 cm, 4 cm, 5 cm, etc. According to some examples, the focus area 415h may have a diameter of on the order of millimeters, such as 1 mm, 2 mm, 3 mm, 4 mm, 5 mm, 6 mm, 7 mm, 8 mm, 9 mm, etc.

In this example, the beam of ultrasonic waves 410g corresponds to relatively lower-frequency transmitted ultrasonic waves and the beam of ultrasonic waves 410h corresponds to relatively higher-frequency transmitted ultrasonic waves. According to this example, the beam of ultrasonic waves 410g is transmitted by ultrasonic transducer elements (or groups of transducer elements) 405a and the beam of ultrasonic waves 410h is transmitted by ultrasonic transducer elements (or groups of transducer elements) 405b. According to some examples, the ultrasonic transducer elements 405a, the ultrasonic transducer elements 405b, or both, may be, or may include, superpixels. In this example, the focus area 415h is relatively smaller than the focus area 415g based, at least in part, on the relatively higher-frequency ultrasonic waves in the beam of ultrasonic waves 410h.

Accordingly, FIG. 4D shows an example in which a control system is configured to control the array of ultrasonic transducer elements 402 to create haptic effects by modifying a peak frequency of transmitted ultrasonic waves. In some examples, the peak frequency of the transmitted ultrasonic carrier waves may be modified in a range of 20 KHz to 600 KHz. In other examples, the peak frequency of the transmitted ultrasonic carrier waves may be modified in a higher range or a lower range.

In this example, in addition to modifying a peak frequency of transmitted ultrasonic waves, the control system is controlling the array of ultrasonic transducer elements 402 to modify both a focus area and a focus depth of transmitted ultrasonic waves. In some such examples, the focus area may be modified in a range from 2 mm to 5 cm. However, alternative examples may involve modifying the focus area in a smaller or a larger range. According to this example, the focus depth changes by at least a distance 420b, which is the distance between the focus area 415g and the focus area 415h. Some such examples may involve modifying the focus depth in a range from 5 mm to 5 cm. However, alternative examples may involve modifying the focus depth in a smaller or a larger range.

In some examples, the control system may control the array of ultrasonic transducer elements 402 to produce at least the focus area 415h, and in some examples the focus areas 415g and 415h, on or in a person's skin, such as the skin of the wearer 205 of FIG. 2B. In some such examples, the distance 425b may correspond to a distance from the array of ultrasonic transducer elements 402 to a position on or in the skin of the wearer 205 of FIG. 2B. In such examples, the focus area 415h may be at least the distance 420b below the surface of the skin of the wearer 205.

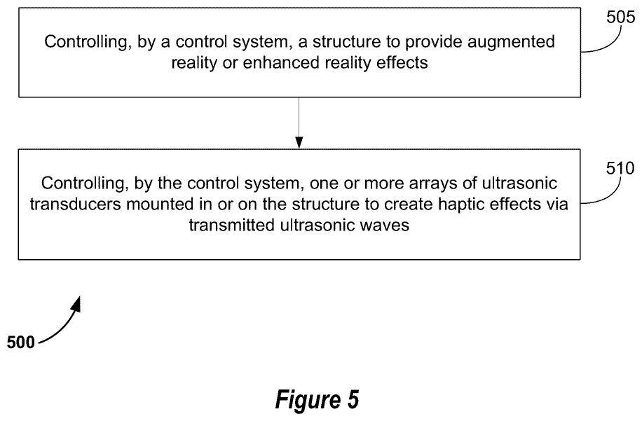

FIG. 5 is a flow diagram that presents examples of operations according to some disclosed methods. The blocks of FIG. 5 may, for example, be performed by the apparatus 101 of FIG. 1, FIG. 2A or FIG. 2B, or by a similar apparatus. For example, in some instances method 300 may be performed, at least in part, by the control system 106 of FIG. 1. As with other methods disclosed herein, the methods outlined in FIG. 5 may include more or fewer blocks than indicated. Moreover, the blocks of methods disclosed herein are not necessarily performed in the order indicated. In some implementations, one or more blocks may be performed concurrently.

According to this example, method 500 involves providing extended reality effects. In some examples, method 500 may involve controlling elements in or on a headset, in or on an eyeglass frame, or elements in or on one or more other devices, to provide extended reality effects. The extended reality effects may include augmented reality effects, mixed reality effects, virtual reality effects, or combinations thereof.

In this example, block 505 involves controlling, by a control system, a structure to provide extended reality effects. In some examples, block 505 may involve controlling a display system of a headset, an eyeglass frame, or another device, to provide images corresponding to the extended reality effects. According to some examples, block 505 may involve controlling a loudspeaker system of a headset, an eyeglass frame, or another device, to provide sounds corresponding to the extended reality effects.

According to this example, block 510 involves controlling, by the control system, one or more arrays of ultrasonic transducer elements mounted in or on the structure to create haptic effects via transmitted ultrasonic waves. In some examples, block 510 may involve controlling, by the control system, one or more arrays of PMUTs mounted in or on the structure to create haptic effects via transmitted ultrasonic waves. In some examples, creating haptic effects via transmitted ultrasonic waves may involve transmitting air-coupled ultrasonic waves. Alternatively, or additionally, creating haptic effects via transmitted ultrasonic waves may involve transmitting ultrasonic waves to a wearer of the apparatus via solid material. The solid material may, for example, include a portion of the structure (for example, a portion of the headset or the eyeglass frame) that is configured to be in contact with the wearer of the apparatus.

In some examples, one or more of the haptic effects may be associated with at least one of the extended reality effects. Alternatively, or additionally, one or more of the haptic effects may be synchronized with at least one of the extended reality effects.

According to some examples, method 500 may involve creating haptic effects via beam steering of transmitted ultrasonic waves. In some examples, a beam steering distance of the beam steering may be in a range from 5 mm to 2 cm. According to some examples, method 500 may involve creating haptic effects via beam steering of transmitted ultrasonic waves corresponding to a motion (such as motion of a focus area of the transmitted ultrasonic waves) along a trajectory. For example, method 500 may involve creating haptic effects corresponding to a motion along a linear trajectory, a curved trajectory, an oval trajectory, a circular trajectory, a sinusoidal trajectory or combinations thereof.

Some examples of method 500 may involve controlling at least one array of the one or more arrays of PMUTs to create haptic effects by modifying a focus area of transmitted ultrasonic waves, a focus depth of transmitted ultrasonic waves, or a combination thereof. In some examples, modifying the focus area may involve modifying the focus area in a range from 2 mm to 5 cm. In some examples, modifying the focus depth may involve modifying the focus depth in a range from 5 mm to 5 cm. Some examples of method 500 may involve transmitting a focused beam of ultrasonic waves by the at least one array at a first time and transmitting an unfocused beam of ultrasonic waves by the at least one array at a second time.

Some examples of method 500 may involve creating haptic effects by modifying a peak frequency of transmitted ultrasonic waves. Some examples of method 500 may involve creating haptic effects via amplitude modulation of transmitted ultrasonic carrier waves. According to some such examples, a frequency of amplitude modulation may be in a range of 40 Hz to 300 Hz. In some such examples, a peak frequency of the transmitted ultrasonic carrier waves may be in a range of 20 KHz to 600 KHz.

Implementation examples are described in the following numbered clauses:
1. An apparatus, including: a structure configured to provide extended reality effects; an ultrasound-based haptic system including one or more arrays of ultrasonic transducers mounted in or on the structure; and a control system configured for communication with the one or more arrays of ultrasonic transducers, the control system being configured to control the one or more arrays of ultrasonic transducers to create haptic effects via ultrasonic waves.
2. The apparatus of clause 1, where the control system is configured to control the one or more arrays of ultrasonic transducers to create haptic effects via air-coupled ultrasonic waves.
3. The apparatus of clause 1 or clause 2, where the control system is configured to control the one or more arrays of ultrasonic transducers to create one or more haptic effects associated with at least one of the extended reality effects.
4. The apparatus of any one of clauses 1-3, where the control system is configured to control the one or more arrays of ultrasonic transducers to create one or more haptic effects synchronized with at least one of the extended reality effects.
5. The apparatus of any one of clauses 1-4, where the structure is, or includes, a headset or an eyeglass frame.
6. The apparatus of any one of clauses 1-5, where at least one array of the one or more arrays of ultrasonic transducers includes ultrasonic transducers grouped into superpixels, each of the superpixels including a plurality of ultrasonic transducers.
7. The apparatus of any one of clauses 1-6, where the extended reality effects include augmented reality effects, mixed reality effects, virtual reality effects, or combinations thereof.
8. The apparatus of any one of clauses 1-7, where the control system is configured to control at least one array of the one or more arrays of ultrasonic transducers to create haptic effects via beam steering of transmitted ultrasonic waves.
9. The apparatus of clause 8, where a beam steering distance of the beam steering is in a range from 5 mm to 2 cm.
10. The apparatus of any one of clauses 1-9, where the control system is configured to control at least one array of the one or more arrays of ultrasonic transducers to create haptic effects by modifying a focus area of transmitted ultrasonic waves, modifying a focus depth of transmitted ultrasonic waves, or a combination thereof
11. The apparatus of clause 10, where modifying the focus area involves modifying the focus area in a range from 2 mm to 5 cm.
12. The apparatus of clause 10 or clause 11, where modifying the focus depth involves modifying the focus depth in a range from 5 mm to 5 cm.
13. The apparatus of any one of clauses 1-12, where the control system is configured to control at least one array of the one or more arrays of ultrasonic transducers to create haptic effects by transmitting a focused beam of ultrasonic waves by the at least one array at a first time and transmitting an unfocused beam of ultrasonic waves by the at least one array at a second time.
14. The apparatus of any one of clauses 1-13, where the control system is configured to control at least one array of the one or more arrays of ultrasonic transducers to create haptic effects by modifying a peak frequency of transmitted ultrasonic waves.
15. The apparatus of any one of clauses 1-14, where the control system is configured to control at least one array of the one or more arrays of ultrasonic transducers to create haptic effects via amplitude modulation of transmitted ultrasonic carrier waves.
16. The apparatus of clause 15, where a frequency of amplitude modulation is in a range of 40 Hz to 300 Hz.
17. The apparatus of clause 15 or clause 16, where a peak frequency of the transmitted ultrasonic carrier waves is in a range of 20 KHz to 600 KHz.
18. The apparatus of any one of clauses 1-17, where the control system is configured to control at least one array of the one or more arrays of ultrasonic transducers to create haptic effects via ultrasonic waves transmitted to a wearer of the apparatus via solid material.
19. The apparatus of clause 18, where the solid material includes a portion of the structure that is configured to be in contact with the wearer of the apparatus.
20. The apparatus of clause 19, where the control system is further configured to control at least one array of the one or more arrays of ultrasonic transducers to create haptic effects by modifying a focus area of transmitted ultrasonic waves in a range of 1 mm to 5 mm, moving a focus area of transmitted ultrasonic waves within a steering range of 1 cm, modifying a focus depth of transmitted ultrasonic waves in a range from 5 mm to 5 cm, or a combination thereof.
21. The apparatus of any one of clauses 1-20, where the control system is further configured to control at least one array of the one or more arrays of ultrasonic transducers to create haptic effects corresponding to a motion along a trajectory.
22. The apparatus of any one of clauses 1-21, where the one or more arrays of ultrasonic transducers include one or more piezoelectric micromachined ultrasonic transducers (PMUTs).
23. The apparatus of clause 22, where the one or more PMUTs include one or more scandium-doped aluminum nitride PMUTs.
24. A method for providing extended reality effects, the method involving: controlling, by a control system, a structure to provide extended reality effects; and controlling, by the control system, one or more arrays of ultrasonic transducers mounted in or on the structure to create haptic effects via transmitted ultrasonic waves.
25. The method of clause 24, where creating haptic effects via transmitted ultrasonic waves involves transmitting air-coupled ultrasonic waves.
26. The method of clause 24 or clause 25, where one or more of the haptic effects is associated with at least one of the extended reality effects.
27. One or more non-transitory media having instructions stored therein for controlling one or more devices to perform a method for providing extended reality effects, the method comprising: controlling, by a control system, a structure to provide extended reality effects; and controlling, by the control system, one or more arrays of ultrasonic transducers mounted in or on the structure to create haptic effects via transmitted ultrasonic waves.
28. The one or more non-transitory media of clause 27, where creating haptic effects via transmitted ultrasonic waves involves transmitting air-coupled ultrasonic waves.
29. The one or more non-transitory media of clause 27 or clause 28, where one or more of the haptic effects is associated with at least one of the extended reality effects.
30. An apparatus, including: a structure configured to provide extended reality effects; an ultrasound-based haptic system including one or more arrays of ultrasonic transducers mounted in or on the structure; and control means for controlling the one or more arrays of ultrasonic transducers to create one or more haptic effects via air-coupled transmitted ultrasonic waves, the one or more haptic effects being associated with at least one of the extended reality effects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations presented herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a sub combination.

Similarly, while operations are depicted in the drawings in a particular order, this should not be understood as requiring that such operations be performed in the particular order presented or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

It will be understood that unless features in any of the particular described implementations are expressly identified as incompatible with one another or the surrounding context implies that they are mutually exclusive and not readily combinable in a complementary or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

What is claimed is:

1. An apparatus, comprising:
a structure configured to provide extended reality effects;
an ultrasound-based haptic system including one or more arrays of ultrasonic transducers mounted in or on the structure; and
a control system configured for communication with the one or more arrays of ultrasonic transducers, the control system being configured to control the one or more arrays of ultrasonic transducers to create haptic effects via ultrasonic waves.

2. The apparatus of claim 1, wherein the control system is configured to control the one or more arrays of ultrasonic transducers to create haptic effects via air-coupled ultrasonic waves.

3. The apparatus of claim 1, wherein the control system is configured to control the one or more arrays of ultrasonic transducers to create one or more haptic effects associated with at least one of the extended reality effects.

4. The apparatus of claim 1, wherein the control system is configured to control the one or more arrays of ultrasonic transducers to create one or more haptic effects synchronized with at least one of the extended reality effects.

5. The apparatus of claim 1, wherein the structure comprises a headset or an eyeglass frame.

6. The apparatus of claim 1, wherein at least one array of the one or more arrays of ultrasonic transducers includes ultrasonic transducers grouped into superpixels, each of the superpixels including a plurality of ultrasonic transducers.

7. The apparatus of claim 1, wherein the extended reality effects include augmented reality effects, mixed reality effects, virtual reality effects, or combinations thereof.

8. The apparatus of claim 1, wherein the control system is configured to control at least one array of the one or more arrays of ultrasonic transducers to create haptic effects via beam steering of transmitted ultrasonic waves.

9. The apparatus of claim 8, wherein a beam steering distance of the beam steering is in a range from 5 mm to 2 cm.

10. The apparatus of claim 1, wherein the control system is configured to control at least one array of the one or more arrays of ultrasonic transducers to create haptic effects by modifying a focus area of transmitted ultrasonic waves, modifying a focus depth of transmitted ultrasonic waves, or a combination thereof.

11. The apparatus of claim 10, wherein modifying the focus area involves modifying the focus area in a range from 2 mm to 5 cm.

12. The apparatus of claim 10, wherein modifying the focus depth involves modifying the focus depth in a range from 5 mm to 5 cm.

13. The apparatus of claim 1, wherein the control system is configured to control at least one array of the one or more arrays of ultrasonic transducers to create haptic effects by transmitting a focused beam of ultrasonic waves by the at least one array at a first time and transmitting an unfocused beam of ultrasonic waves by the at least one array at a second time.

14. The apparatus of claim 1, wherein the control system is configured to control at least one array of the one or more arrays of ultrasonic transducers to create haptic effects by modifying a peak frequency of transmitted ultrasonic waves.

15. The apparatus of claim 1, wherein the control system is configured to control at least one array of the one or more arrays of ultrasonic transducers to create haptic effects via amplitude modulation of transmitted ultrasonic carrier waves.

16. The apparatus of claim 15, wherein a frequency of amplitude modulation is in a range of 40 Hz to 300 Hz.

17. The apparatus of claim 15, wherein a peak frequency of the transmitted ultrasonic carrier waves is in a range of 20 KHz to 600 KHz.

18. The apparatus of claim 1, wherein the control system is configured to control at least one array of the one or more arrays of ultrasonic transducers to create haptic effects via ultrasonic waves transmitted to a wearer of the apparatus via solid material.

19. The apparatus of claim 18, wherein the solid material includes a portion of the structure that is configured to be in contact with the wearer of the apparatus.

20. The apparatus of claim 19, wherein the control system is further configured to control at least one array of the one or more arrays of ultrasonic transducers to create haptic effects by modifying a focus area of transmitted ultrasonic waves in a range of 1 mm to 5 mm, moving a focus area of transmitted ultrasonic waves within a steering range of 1 cm, modifying a focus depth of transmitted ultrasonic waves in a range from 5 mm to 5 cm, or a combination thereof.

21. The apparatus of claim 1, wherein the control system is further configured to control at least one array of the one or more arrays of ultrasonic transducers to create haptic effects corresponding to a motion along a trajectory.

22. The apparatus of claim 1, wherein the one or more arrays of ultrasonic transducers may include one or more piezoelectric micromachined ultrasonic transducers (PMUTs).

23. The apparatus of claim 22, wherein the one or more PMUTs include one or more scandium-doped aluminum nitride PMUTs.

24. A method for providing extended reality effects, the method comprising:
controlling, by a control system, a structure to provide extended reality effects; and
controlling, by the control system, one or more arrays of ultrasonic transducers mounted in or on the structure to create haptic effects via transmitted ultrasonic waves.

25. The method of claim 24, wherein creating haptic effects via transmitted ultrasonic waves involves transmitting air-coupled ultrasonic waves.

26. The method of claim 24, wherein one or more of the haptic effects is associated with at least one of the extended reality effects.

27. One or more non-transitory media having instructions stored therein for controlling one or more devices to perform a method for providing extended reality effects, the method comprising:
controlling, by a control system, a structure to provide extended reality effects; and
controlling, by the control system, one or more arrays of ultrasonic transducers mounted in or on the structure to create haptic effects via transmitted ultrasonic waves.

28. The one or more non-transitory media of claim 27, wherein creating haptic effects via transmitted ultrasonic waves involves transmitting air-coupled ultrasonic waves.

29. The one or more non-transitory media of claim 27, wherein one or more of the haptic effects is associated with at least one of the extended reality effects.

30. An apparatus, comprising:
a structure configured to provide extended reality effects;
an ultrasound-based haptic system including one or more arrays of ultrasonic transducers mounted in or on the structure; and
control means for controlling the one or more arrays of ultrasonic transducers to create one or more haptic effects via air-coupled transmitted ultrasonic waves, the one or more haptic effects being associated with at least one of the extended reality effects.
